(19) United States
(12) Patent Application Publication
(10) Pub. No.: US 2004/0164233 A1
(43) Pub. Date: Aug. 26, 2004

(54) Colour sensing apparatus and method

(76) Inventor: Peter Hemingway, Bristol (GB)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/625,898

(22) Filed: Jul. 24, 2003

(30) Foreign Application Priority Data
Jul. 25, 2002 (GB) GB 0217258.3

(51) Int. Cl. H01J 40/14

(52) U.S. Cl. 250/226

(57) ABSTRACT

Using a plurality of relatively narrowband light sensors having overlapping response characteristics, accurate and self-calibrating colour measurements may be carried out. With sufficient measurements, simultaneous equations may be solved to derive a light intensity measurement at portions of the spectrum at which the overlapping sensor responses intercept. Using LEDs as light sensors provides cheap narrowband sensors and provides the additional advantage that the LEDs may also be used to illuminate a source to provide additional cross-reference measurements. Using sensors and/or illumination sources directed at several angles may also be used to improve sensing accuracy by mitigating the effects of surface texture and/or fluorescence.

### BACKGROUND OF THE INVENTION

1. Field of the Invention

This invention relates to colour sensors and to a method of sensing colour.

2. Related Background Art

Accurate repeatable colour measurements are required, for example in printing and paint manufacture technologies, in order to produce repeatable results.

The general physical principles for accurate colour sensing are therefore well known. In particular, typically a known colour temperature for an illuminant light source and known response characteristics for a reflected light detector are required. Furthermore, subjective factors which alter colour perceptions such as a fluorescence and surface textures need to be taken into account. If these factors are not considered in the design of a colour sensor, it is possible that erroneous readings will be made for example as a result of inadequate distinction between metameters (i.e. colours which look the same but are in fact different) producing poor repeatability of measurements.

Traditionally, colour sensing over a wide range of colours has been achieved in a variety of ways. One option has been to provide a single wide band sensor and to interpose different filters between the sensor and incident light thereby taking an intensity reading in different portions of the colour spectrum. This has the disadvantage of requiring moving components such as mirrors to interpose filters and/or move the sensor relative to a fixed filter. Another approach is to divide the incident light into different portions, for example using a prism, and directing the different portions to a plurality of wide band sensors. Although this does away with a need for moving parts, calibration is difficult due to manufacturing tolerances in the multiple sensors. A further option is to use a wide band sensor with several (typically three) different illuminant colours.

Accordingly, present colour sensors are often either cheap and inaccurate or relatively expensive, cumbersome and/or fragile.

### SUMMARY OF THE INVENTION

In accordance with a first aspect of the invention there is provided a colour sensor having a plurality of photosensitive devices of differing and overlapping spectral responses and switching means arranged to read the electrical output of each photosensitive device separately and wherein the photosensitive devices are LEDs.

The approach taken by the present invention of multiple sensors with different but overlapping spectral responses means that different portions of the spectrum can be sensed directly and that the relative characteristics of the different sensors can be self-calibrated due to the overlapping nature of the response curve. This is explained in more detail below. Furthermore, no moving parts are required.

The photo-sensitive devices are LEDs. LEDs are designed to emit in a narrow wave band. This may be achieved in part by the composition of the semi-conductor device which provides a relatively narrow range of band gaps of predetermined energy which in turn causes the emission of photons of particular wavelengths. This may also be achieved or enhanced by including colour filters in the LED package. However, by effectively using an LED in reverse by sensing current in the LED connecting leads when light is incident on the diode junction, a relatively cheap, readily available and highly effective narrowband photosensor is obtained. Furthermore, by illuminating a sample with narrow wavelength ranges of light and sensing in narrow wavelength ranges, the effects of fluorescence are mitigated.

More preferably, the LEDs may be used at different times, both in light emitting and light sensing modes. By sequentially switching the LEDs between modes, a combination of different colour illuminant sources and different colour photo sensors may be used to further cross check and self-calibrate the results.

In another aspect, the invention provides a colour sensor having a plurality of LEDs each oriented to illuminate a sample to be sensed, from at least two different angles, the sensor further including LEDs arranged to sense light reflected from the sample.

By illuminating a sample to be sensed from a plurality of angles, effects such as surface texture are mitigated to obtain an accurate measurement.

By combining this invention with the ideas of the first aspect above, it is possible to produce many combinations of incident and reflected light sensing, for example by using three LEDs of each colour at different angles and using each of the three in turn as an illuminant and sensing reflected light using the other two of the set of three and/or additionally differently coloured LEDs.

In a third aspect, the invention provides a colour sensor comprising a plurality of LEDs constructed to provide differing spectral light emissions and each oriented to receive reflected light from a predetermined sensing location.

In this aspect, LEDs are used as photosensitive devices. Preferably also, the LEDs are re-used to illuminate a sample to be sensed.

In a method aspect, the invention provides a method of sensing colour comprising illuminating a sample to be sensed and arranging for at least one LED to receive reflected light from the sample whereby the electrical output of the LED is used to provide an indication of the reflected light energy in the emission band of the LED.

### BRIEF DESCRIPTION OF THE DRAWINGS

Embodiments of colour sensors will now be described by way of example with reference to the drawings in which:—

FIG. 1 is a schematic diagram of a prior art prism-based sensor;

FIG. 2 is a schematic plot of light response for a plurality of relative narrow band light sensors against wavelength;

FIG. 3 is a schematic cross-section of a plurality of emitters and narrow band sensors;

FIG. 4 is a schematic diagram of a switching circuit for the emitters and sensors of FIG. 3;

FIG. 5 is a schematic diagram showing the effects of fluorescence and surface texture on reflected light;

FIG. 6 is a schematic plan view of an angled sensor;

FIG. 7 is a schematic cross-section along line VII-VII of FIG. 6;

FIG. 8 is a schematic diagram showing a plurality of LEDs being used as photo sensors with broadband illumination;

FIG. 9 is a schematic diagram of a switching circuit using LEDs as both photo sensors; and

FIG. 10 is a schematic diagram of a modified embodiment of the circuit of FIG. 9 arranged to use the LEDs also as light emitters.

### DETAILED DESCRIPTION OF THE PREFERRED EMBODIMENTS

With reference to FIG. 1, in the prior art, colour has been sensed typically using a broadband light source 2 illuminating a sample to be sensed 4 which produces reflected light 8. This is then passed through a lens system (not shown) to a prism 6. The prism 6 produces an angular deflection of the light which is dependent on the light wavelength and therefore spreads the incoming beam 8 into a continuum of beams 10 of differing wavelengths (and therefore colours). The beams 10 are directed at an array of photo sensors 12 each of which has a similar broad band response characteristic. In this way, the sensors 12 are caused to respond to different portions of the light spectrum of reflected beam 8.

By reading the outputs of each of the sensors 12, it is possible to derive an estimate of the energy in each of the different colour bands produced by the prism 6. However, any variations in the response characteristics of the sensors 12 will cause inaccuracies in the colour measurement which cannot be readily allowed for.

An alternative approach is to use a single broad band sensor and to arrange for coloured filters to be passed between the sensor and a reflected beam or alternatively to cause relative movement of the sensor and a stationary set of filters. This has the clear disadvantage of requiring precision moving parts which are both expensive and vulnerable to damage through excessive vibration, for example.

A further alternative is to use a single broad band sensor and a plurality of differently coloured illuminant sources.

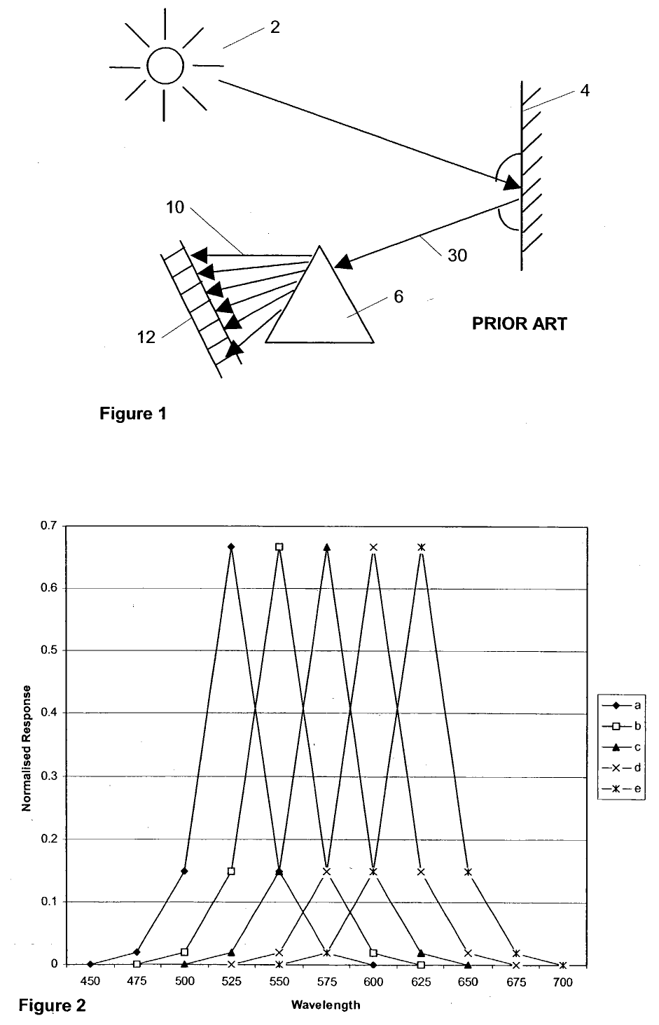

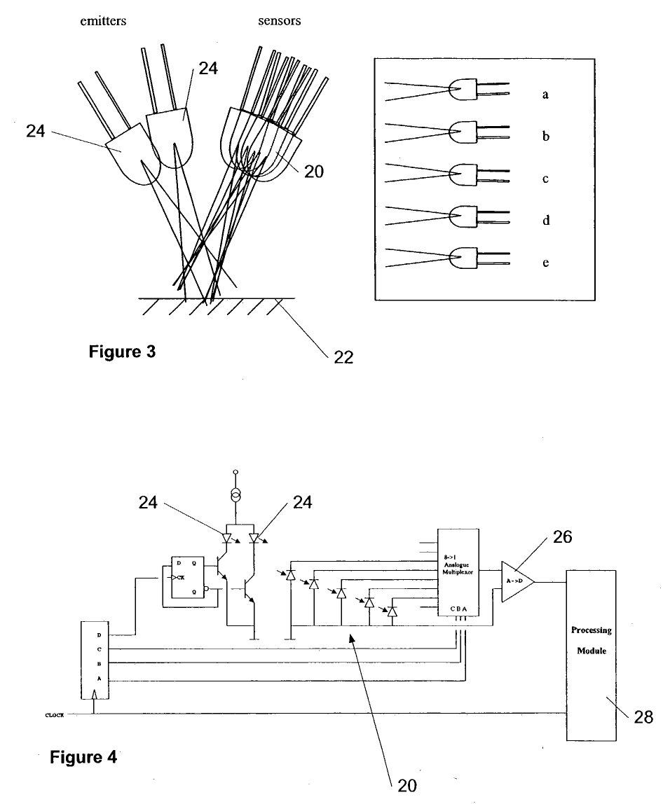

An alternative configuration is shown in FIG. 3. In this configuration a plurality of narrow band sensors 20 are arrayed to receive reflected light from a portion of a sample 22. Optionally also, relatively narrow band illumination sources 24 may be provided to illuminate the sample 22. With reference also to FIG. 2, it will be noted that the response characteristics of the sensors 20 are chosen not only to be relatively narrow band but also to overlap with at least one of its spectrally adjacent sensors.

In the example shown in FIG. 2, the sensors each have a wavelength range of approximately 150 nm with identical response curves. However, the principles set out below will, it will be appreciated, work equally well for irregularly spaced wavelength responses and non-uniform and dissimilar response curves.

In general, as long as the number of unique measurements is at least the same as the number of unknowns, simultaneous equations can be solved to find the unknowns and thereby determine the quantity of light received in any particular intersecting area of the different curves. In this example, it is desired to determine light energy in nine bands (which in this case are of 25 nm wavelength spacings). Thus there are nine unknowns and using five differing sensor and two emitters (or vice versa) ten effective measurements can be made providing sufficient information to find a solution to the light energy in each of the nine bands.

By illuminating the sample in only part of the spectrum by activating only one of the emitters 24 at a time, and reading every sensor with overlapping responses, five results are produced. By illuminating the other emitter, an additional five independent results are again produced.

For example, if a is an emitter and e is a sensor then the only area of overlap is around 575 nm. Only 1.9% of light emitted by a is in this region and sensor e has a reduced sensitivity of only 1.9%. If the response of sensor e under illumination from a Rₑ₍ₐ₎ then the amount of light reflected in the 575 nm region is 0.019×0.019×the amount of light in that region, L₅₇₅.

Sensors b and e overlap in both 575 nm and 600 nm ranges so here, R_{e(b)}=0.019×0.15×L₅₇₅+0.15×0.019×L₆₀₀. However, L₅₇₅ is already know from Rₑ₍ₐ₎ and therefore L₆₀₀ can be calculated by substituting the value of L₅₇₅ into L₆₀₀. Similarly this process can be carried out for L₆₂₅ and so on. The tenth measurement Rₐ₍ₑ₎ is redundant because it duplicates Rₑ₍ₐ₎. However, this can be used as a cross-check.

Thus, as long as the individual response curves of each sensor is known (and the emission curve of the optional LED emitter is known) by solving simultaneous equations in the way set out above, it is possible to derive precise and self-calibrated measurements for narrow bands much narrower than the narrow band response of the sensors themselves. By using additional differing sensors and/or emitters, further measurements may be taken which may be used to narrow the sensing bands even further or to provide additional cross-checks and therefore self-calibration capability.

FIG. 4 shows a schematic block diagram for a circuit arranged sequentially to illuminate the sample 22 with emitter a and then cycle through the responses of each of the five sensors 20 and then to illuminate the sample with a second emitter and again take a reading from each of the sensors. The readings are sampled using an ADC converter 26 and then processed in processing module 28 to solve the simultaneous equations that produce quantitive indications of light in each of the narrow (25 nm) bands.

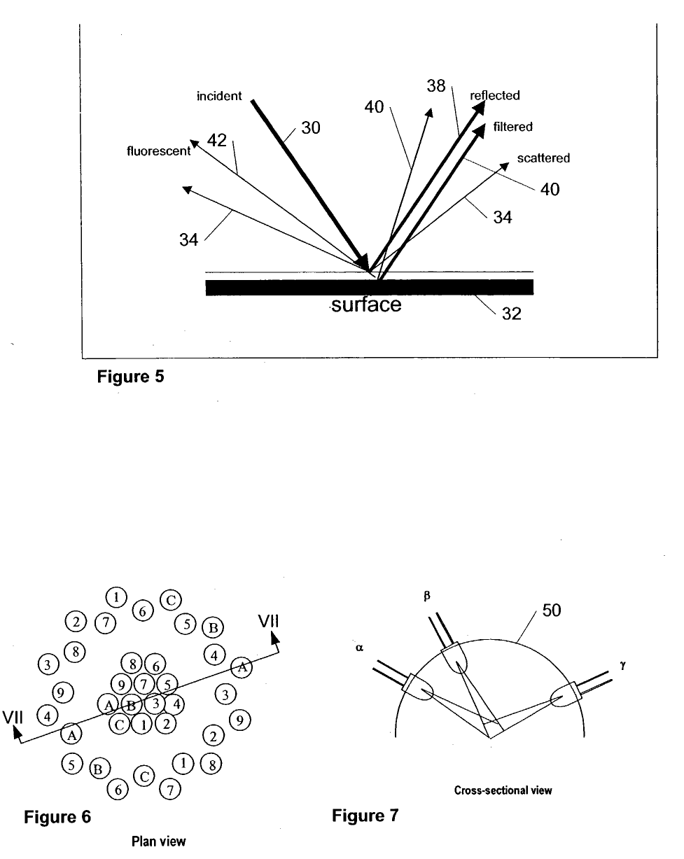

With reference to FIG. 5, the problem of taking accurate colour measurements is illustrated. An incident beam 30 strikes a coated surface 32. A scattering beam 34 is produced by the coated surface 36. Additionally a reflected beam 38 is produced.

A filtered beam 40 is produced which is representative of the colour of the surface 32. However, a fluorescent beam 42 is also produced which emits energy outside or overlapping the spectrum of the filtered beam 40. If the surface 36 is uneven then scattering is pronounced. This combination of scattering, and fluorescence can produce significant changes in colour perception. However, for reproducibility, it is desirable to determine both the true colour of the surface by measuring the filtered beam 40 and also to measure the fluorescence.

In the prior art, surface textures have been dealt with by taking two measurements at 90° and at 45° to the surface of the sample to be measured. This produces limited results.

Having realised, and as described in part above, that LEDs may be used conveniently both as light sources and light sensors, a compact and robust sensing head may be produced. In FIG. 7, a generally hemi-spherical housing (although this could be some other shape) 50 is shown. Three LEDs α, β and γ are shown in section which are used in sequence to illuminate and sense a sample 60. With reference also to FIG. 6, it will be noted that the sensing head has a plurality of LEDs arrayed around the housing 50. Using each of these or a subset of these as sensors whilst illuminating with one or perhaps more than one LED, and applying the narrow band sensing technique described above, produces accurate measurements at many combinations of illuminant and sensing angles. This overcomes the problems of fluorescence and surface texture described above in connection with FIG. 5. Furthermore, using the techniques described above in connection with FIG. 2, it is possible to detect fluorescence by sensing energy in bands for sensors at particular angles which is not sensed at other angles. This may be simply flagged and/or quantified.

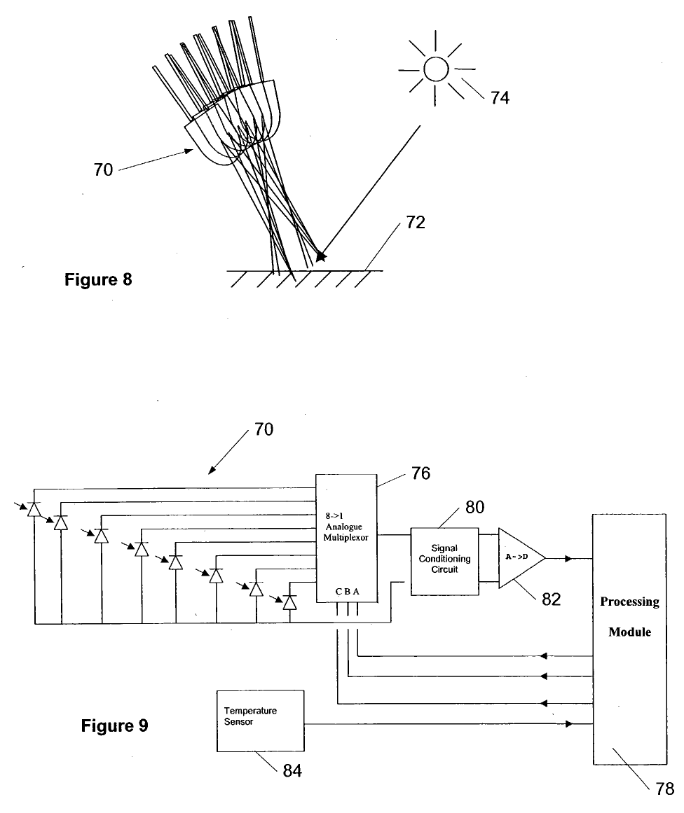

FIG. 8 shows schematically the principle of using a plurality of LEDs 70 as light sensors. The LEDs 70 are arrayed to be directed generally at a sample 72. The sample 72 is illuminated using a broad band light source 74 and the electrical connectors of the LEDs are switched sequentially (using, for example, the circuit of FIG. 9).

With reference to FIG. 9, an eight channel analogue multiplexer 76 is controlled by a processing module 78 which sequentially reads the electrical outputs for each of the eight LEDs 70. A signal conditioning circuit 80 provides appropriate buffering and amplification before the signals are passed to an ADC 82 and thereon to the processing module 78. The processing module 78 also receives an input from a temperature sensor 84 which allows temperature calibration of the LEDs to be carried out.

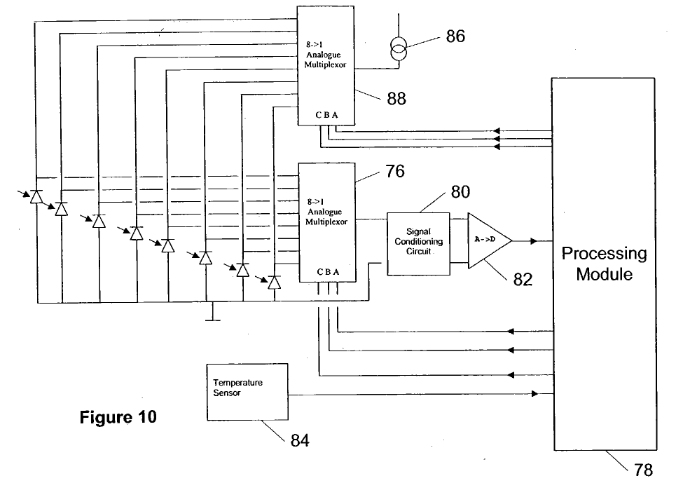

With reference to FIG. 10, by modifying the circuit of FIG. 9 to include a current source 86 and an analogue demultiplexer 88 under control of the processing module 78, it is possible to use the LEDs 70 both as switchable relatively narrow band light sources and as light sensors. This allows similar operation to the circuit of FIG. 4.

As described briefly above, this combination of elements allows convenient, cheap and robust light sensing to take place and in particular, when used the techniques described above, provides accurate colour sensing.

More generally, the techniques described above which may be used individually or in any combination, allow a compact robust relatively cheap and efficient colour sensor to be made. This may used for example to allow a consumer to record colour samples from articles such as textiles or paint colours and to conveniently carry them to another place to allow colour matching to be made. The processed output of the sensor may be used to provide an accurate quantitive measure of the colour. It may also be used to provide information such as whether colours are complementary or clashing. These techniques may also be used for example to improve colour rendition for example in printing processes by allowing accurate colour sensing to be carried out more cheaply and therefore in printers at a lower price point.

What is claimed is:

1. A colour sensor having a plurality of photosensitive devices of differing and overlapping spectral responses and switching means arranged to read the electrical output of each photosensitive device separately and wherein the photosensitive devices are LEDs.

2. A colour sensor according to claim 1, wherein the photosensitive devices are each oriented at different angles relative to a sample to be sensed.

3. A colour sensor according to claim 1, wherein a subset of the LEDs is used to illuminate a sample to be sensed and at least one of the remaining LEDs is used to sense light reflected from the sample.

4. A colour sensor according to claim 3, wherein the photosensitive devices are each oriented at different angles relative to a sample to be sensed.

5. A colour sensor according to claim 4, including angle switching means arranged to activate the LEDs in a predetermined sequence and to switch the electrical outputs of the non-activated LEDs to an output of the sensor, in a predetermined sequence, whereby the differing angles of the LEDs are used to produce a plurality of combinations of light incident on and sensed light reflected from a sample to be sensed.

6. A colour sensor having a plurality of LEDs each oriented to illuminate a sample to be sensed, from at least two different angles, the sensor further including LEDs arranged to sense light reflected from the sample.

7. A colour sensor according to claim 6, including switching means arranged to activate the LEDs in a predetermined sequence and to switch the electrical outputs of the non-activated LEDs to an output of the sensor, in a predetermined sequence, whereby the differing angles of the LEDs are used to produce a plurality of combinations of light incident on and sensed light reflected from a sample to be sensed.

8. A colour sensor comprising a plurality of LEDs, constructed to provide differing spectral light emissions and each oriented to receive reflected light from a predetermined sensing location.

9. A sensor according to claim 8, wherein each LED is oriented to direct emitted light at a predetermined sensing location and the sensor further includes switching means arranged to switch the LEDs to activate predetermined sets of the LEDs to emit light and to direct the electrical outputs of the non-activated LEDs to the sensor output.

10. A method of sensing colour comprising illuminating a sample to be sensed and arranging for at least one LED to receive reflected light from the sample whereby the electrical output of the LED is used to provide an indication of the reflected light energy in the emission band of the LED.

11. A method according to claim 10 including illuminating the sample using at least one LED, switching the LEDs in a predetermined sequence and switching the electrical outputs of the non-activated LEDs to an output of the sensor, in a predetermined sequence, whereby the differing angles of the LEDs are used to produce a plurality of combinations of light incident on and sensed light reflected from a sample to be sensed.
